(19) United States
(12) Patent Application Publication
(10) Pub. No.: US 2006/0293959 A1
(43) Pub. Date: Dec. 28, 2006

(54) Method and system for adding coupon information to network-based content

(75) Inventor: Michael P. Hogan, Belmont, CA (US)

Correspondence Address: BROWDY AND NEIMARK, P.L.L.C.;624 NINTH STREET, NW, SUITE 300, WASHINGTON, DC, 20001-5303, US

(73) Assignee: Zixxo Inc., Belmont, CA (US)

(21) Appl. No.: 11/453,243

(22) Filed: Jun. 15, 2006

Related U.S. Application Data
(60) Provisional application No. 60/690,675, filed on Jun. 16, 2005.

(51) Int. Cl. G06Q 30/00

(52) U.S. Cl. 705/14

(57) ABSTRACT

Some embodiments of the invention relate to a method and a system for enabling a user utilizing a computerized device connected to a network to receive targeted incentive offers. According to some embodiments of the invention, a system for enabling a user utilizing a computerized device connected to a network to receive targeted incentive offers may include a coupon publisher and an agent. The coupon publisher may be adapted to associate one or more coupons with an incentive criterion. The agent may be operative to evaluate at least a portion of data being exchanged between the computerized device and at least a second computerized device to identify static content within the data which is in compliance with the incentive criterion. The agent may be further adapted to associate the static content determined to be in compliance with the incentive criterion with a hyperlink which is configured to link towards one or more coupons associated with the incentive criterion upon the execution of the hyperlink.

### CROSS REFERENCE TO RELATED APPLICATIONS

This application claim priority from Provisional Patent Application No. 60/690,675, filed on Jun. 16, 2005.

### FIELD OF THE INVENTION

The present invention relates to a method and a system for enabling a user utilizing a computerized device connected to a network to receive targeted incentive offers based upon the user's content exchanges over the network.

### BACKGROUND OF THE INVENTION

Users consume information in the form of web content, instant messages, email, etc. This information might, at times, trigger a desire to execute a purchase, either online or offline. A cost-conscious user might then search for coupons for said purchase. However, searching for coupons can be a time-consuming process, especially when said coupons are maintained on various disparate merchant websites. From another perspective, service providers can increase usage and improve service by providing users with the option to receive incentive offers in connection with their areas of interest. In both cases, it would be desirable for the offers provided to the user to be well targeted and non-invasive in presentation, so as not to harm the user's web-surfing experience unnecessarily.

U.S. Published Patent Application No. 2002/0056091 (Bala et al.) discloses a software agent for locally tracking a user's network interaction, such as web browsing, and providing targeted promotions with optional coupons to the user. The monitoring involves use of a downloaded file of network addresses and words potentially tailored to each individual user. The software agent locally compares addresses of sites accessed and words used in searching to the stored addresses and key words in the file. Upon detecting a match, the software agent contacts a system server to obtain a promotion with an optional coupon for the match, and displays an indication of the promotion or coupon to the user, providing the user with the option to view or decline the promotion. The user is provided with redeemable credits for viewing promotions, which can include transferring the user to a site of a merchant offering the promotion. The coupons can include coupons targeted to users geographically close to particular merchants so that the coupons can be printed and redeemed at the merchant's establishment.

### SUMMARY OF THE INVENTION

Some embodiments of the invention relate to a method and a system for enabling a user utilizing a computerized device connected to a network to receive targeted incentive offers. According to some embodiments of the invention, a system for enabling a user utilizing a computerized device connected to a network to receive targeted incentive offers may include a coupon publisher and an agent. The coupon publisher may be adapted to associate one or more coupons with an incentive criterion. The agent may be operative to evaluate at least a portion of data being exchanged between the computerized device and at least a second computerized device to identify data corresponding to static content which is in compliance with the incentive criterion. The agent may be further adapted to associate the static content determined to be in compliance with the incentive criterion with a hyperlink which is configured to link towards one or more coupons associated with the incentive criterion upon the execution of the hyperlink.

According to further embodiments of the invention, the system may also include a query processor. The query processor may be adapted to associate the hyperlink with a query, such that when the hyperlink is executed the query is initiated on a coupon repository. According to some embodiments of the invention, the query processor may be adapted to configure the query to retrieve from the repository data in respect of any currently available coupons within the repository which are associated with the incentive criterion upon the initiation of the query.

According to yet further embodiments of the invention, the system may also include a user information module comprising personal data about the user. According to some embodiments of the invention, the query processor may be adapted to include within the query one or more terms created based upon data from said user information module. According to further embodiments of the invention, the user information module may include any of the following data with respect to a user: personal data of the user, user's name, user's gender, user's personal status, user's occupation, user's hobbies and field of interest, user's age, authentication information, user's geographical location and other contact information, user's preferences, user's usage history.

According to still further embodiments of the invention, the agent may be utilized by a service provider to evaluate compliance of content being exchanged through the service provider with a predefined incentive criterion, and the agent may be adapted to associate static content determined to be in compliance with the incentive criterion with a hyperlink which is configured to link towards one or more coupons associated with the incentive criterion upon the execution of the hyperlink. According to some embodiments of the invention, the agent may be utilized by the service provider to associate static content determined to be in compliance with the incentive criterion with a hyperlink which is configured to link towards one or more coupons associated with the incentive criterion, such that the content arrives to its destination with the hyperlinks associated therewith.

According to yet further embodiments of the invention, the system may also include a coupon cache module. According to some embodiments of the invention, the coupon cache module may be adapted to obtain from the coupon publisher data in respect of an incentive criterion to enable the agent module to evaluate content being exchanged in accordance with the incentive criterion without having to consult the coupon publisher with respect to the incentive criterion.

Further embodiments of the invention relate to method of enabling a user utilizing a computerized device connected to a network to receive targeted incentive offers. According to some embodiments of the invention, the method may include associating one or more coupons with one or more a predefined incentive criterion, evaluating at least a portion of data being exchanged between said computerized device and at least a second computerized device to identify data corresponding to static content which is in compliance with the incentive criterion, and associating the static content determined to be in compliance with the incentive criterion with a hyperlink which is configured to link towards one or more coupons associated with the incentive criterion upon the execution of the hyperlink.

According to further embodiments of the invention, associating the static content determined to be in compliance with the incentive criterion with a hyperlink may further include associating the hyperlink with a query, such that when the hyperlink is executed the query is initiated on a coupon repository. According to still further embodiments of the invention, associating the hyperlink with a query may further include configuring the query to retrieve from the repository data in respect of any currently available coupons within the repository which are associated with the incentive criterion upon the initiation of the query. According to yet further embodiments of the invention, the association of the hyperlink with a query may also include adding to the query one or more terms created based upon user information. According to still further embodiments of the invention, adding to the query one or more terms created based upon user information may include accessing a data source including information about the user, and generating a query term to be incorporated into the query based upon data from the data source including information about the user.

According to some embodiments of the invention, evaluating the data being exchanged may include intercepting the data being exchanged before the data arrives to its destination, and associating the content with a query on an intermediate computerized device, such that the content may arrive to its destination together with the hyperlinks.

### BRIEF DESCRIPTION OF THE DRAWINGS

In order to understand the invention and to see how it may be carried out in practice, a preferred embodiment will now be described, by way of non-limiting example only, with reference to the accompanying drawings, in which:

FIG. 1 is a block diagram illustration of a system for enabling a user utilizing a computerized device connected to a network to receive targeted incentive offers, according to some embodiments of the invention;

FIG. 2 is a graphical illustration of a first display, displaying original content corresponding to data being exchanged over a network, and of a second display, displaying enhanced content created by associating certain words or phrases from the data being exchanged with a hyperlink which is configured to link towards one or more coupons, according to some embodiments of the invention; and

FIG. 3 is a block diagram illustration of a system for enabling a user utilizing a computerized device connected to a network to receive targeted incentive offers, according to further embodiments of the invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF EXEMPLARY EMBODIMENTS

In the following detailed description, numerous specific details are set forth in order to provide a thorough understanding of the invention. However, it will be understood by those skilled in the art that the present invention may be practiced without these specific details. In other instances, well-known methods, procedures and components have not been described in detail so as not to obscure the present invention.

Unless specifically stated otherwise, as apparent from the following discussions, it is appreciated that throughout the specification discussions utilizing terms such as “processing”, “computing”, “calculating”, “determining”, “generating”, “assigning” or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

Embodiments of the present invention may include apparatuses for performing the operations herein. This apparatus may be specially constructed for the desired purposes, or it may comprise a general purpose computer selectively activated or reconfigured by a computer program stored in the computer. Such a computer program may be stored in a computer readable storage medium, such as, but not limited to, any type of disk including floppy disks, optical disks, CD-ROMs, magnetic-optical disks, read-only memories (ROMs), random access memories (RAMs) electrically programmable read-only memories (EPROMs), electrically erasable and programmable read only memories (EEPROMs), magnetic or optical cards, or any other type of media suitable for storing electronic instructions, and capable of being coupled to a computer system bus.

The processes and displays presented herein are not inherently related to any particular computer or other apparatus. Various general purpose systems may be used with programs in accordance with the teachings herein, or it may prove convenient to construct a more specialized apparatus to perform the desired method. The desired structure for a variety of these systems will appear from the description below. In addition, embodiments of the present invention are not described with reference to any particular programming language. It will be appreciated that a variety of programming languages may be used to implement the teachings of the inventions as described herein.

Throughout the specification and the claims the term “static content” or the like, unless specifically stated otherwise, shall be used to mean any content or portion of content, and specifically of electronic content, which does not include or which is not associated with a hyperlink from the content's original source. In other words static content is any content, such as a word or a phrase to which the author did not add a hyperlink, and as such the content is static, meaning without a hyperlink. Static content may include, but is not limited to, non-hyperlink words or phrases within IM messages, email messages, HyperText Markup Language documents, XML documents, etc.

Throughout the specification and the claims the term “coupon” or the like, unless specifically stated otherwise, shall be used to mean any form of promotional marketing such as a special offer, incentive offer, coupon or discount of some kind. The coupons to which some embodiments of the present invention relate may include, but are not limited to, electronic-coupon or coupons, tangible coupons (or electronic data necessary for generating a tangible coupon) and coupons requiring an activation code, coupons requiring authentication, coupons which are dependent upon a specific user attribute (such as previous redemption of an associated coupon), etc.

Throughout the specification and the claims the term “computerized device” or the like, unless specifically stated otherwise, shall be used to mean any computer, network device or computer-like device which may be used for interacting with another computerized device over a network, including but not limited to a mobile phone, a computer, a personal digital assistant (PDA).

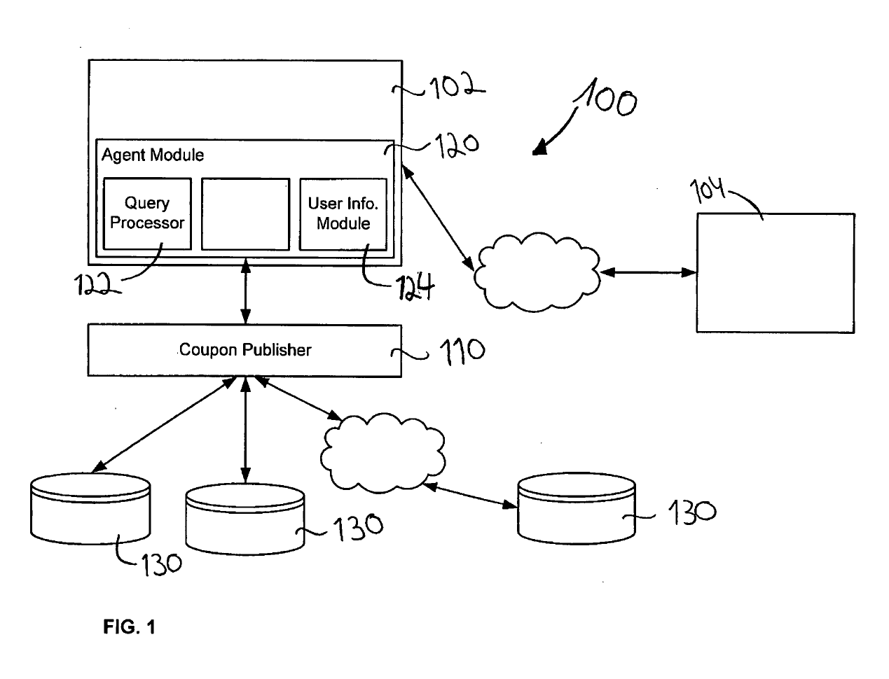

Reference is now made to FIG. 1, which is a block diagram illustration of a system for enabling a user utilizing a computerized device connected to a network to receive targeted incentive offers, according to some embodiments of the invention. According to some embodiments of the invention, the system 100 may include a coupon publisher 110 and an agent module 120. The coupon publisher 110 may be adapted to associate one or more coupons with an incentive criterion. In FIG. 1, and according to some embodiments of the invention, the agent module 120 may reside within a first computerized device 102 operated by the user which is the intended recipient of the incentive offers. However, it should be noted that the present invention is not limited in this respect, and according to further embodiments of the invention, the agent module 120 may not necessarily reside on the computerized device 102 operated by the user, and may instead or in addition, reside on, for example, an intermediary server, as will be described in further detail below.

The agent module 120 may be operative to evaluate at least a portion of data being exchanged between the computerized device 102 operated by the user and at least a second computerized device 104 to identify data corresponding to static content which is in compliance with an incentive criterion. The agent module 120 may be further adapted to associate the static content determined to be in compliance with the incentive criterion with a hyperlink which is configured to link towards one or more coupons associated with the incentive criterion upon the execution of the hyperlink.

According to some embodiments of the invention, the agent module 120 may be in communication with the coupon publisher 110. The agent module 120 may be connected to the coupon publisher 110 directly or through a network connection. As mentioned above, the coupon publisher 110 may be adapted to associate one or more coupons with an incentive criterion. According to some embodiments of the invention, the coupon publisher 110 may be operatively connected to one or more coupon repositories 130 (either directly or though a network). The coupon publisher 110 may be adapted to interact with the coupon repositories 130 and may use any suitable interaction techniques to enable the interaction, including but not limited to the use of an application program interface (API). Similarly, the agent module 120 and the coupon publisher 110 may also use similar and possibly identical techniques to enable and manage the interaction therebetween. The API may be used, for example, to define how the agent module 120 through the coupon publisher 110, for example, can access information about coupons, coordinate the flow of information between the agent module 120 and the coupon publisher 110 and vice-versa, and manage other such information necessary to facilitate the association of a hyperlink towards a coupon with previously static content that is determined to be in compliance with an incentive criterion associated with the coupon. It would be appreciated that according to some embodiments of the invention, a standard API may be used to interact with multiple standards-compliant coupon repositories, or there may be used multiple APIs for interacting with multiple coupon repositories, or there may be a single API for interacting with a single coupon repository, to name just a few of the possibilities.

According to some embodiments of the invention, each coupon repository 130 may include data in respect of one or more coupons. According to some embodiments of the invention, a coupon repository 130 may include data corresponding to an electronic-coupon or coupons, data linking to an electronic-coupon or coupons, data necessary for activating an electronic-coupon or coupons, authentication data for authenticating a user to enable access to a coupon and/or data necessary for creating a tangible coupon or coupons (for example, data necessary for creating a printable image of a valid coupon). According to some embodiments of the invention, the coupon repositories 130 may include additional data in respect of a coupon, as will be described in further detail below.

According to some embodiments of the invention, the coupon publisher 110 may be adapted to associate one or more coupons to which the data in the repositories 130 relates with an incentive criterion. According to some embodiments of the invention, the coupon publisher 110 may be adapted to create the incentive criterion based on data obtained from the repositories 130. According to some embodiments of the invention, the repository 130 may include, for one or more coupons, explicit data in respect of the incentive criterion associated with a coupon (as may be provided for example by the issuer of the coupon), and in this case the coupon publisher 110 simply collects the incentive criterion in respect of the coupon from the repository 130; and/or the repository may include descriptive data in respect of the coupon and the coupon publisher 110 may be adapted to create or derive the incentive criterion based upon metadata or based upon other descriptive data in respect of the coupon, which may be found, for example, in the coupon repository 130. For example, the coupon publisher 110 may be adapted to scan metadata associated with coupons stored within a coupon repository 130 associated with the coupon publisher 110, and based on the metadata (or based upon any other descriptive data), the coupon publisher 110 may generate an incentive criterion that is to be associated with the coupon. According to some embodiments of the invention, the coupon repository 130 may include in respect of a coupon metadata or other (descriptive) data associated with the coupon, including but not limited to, the issuing entity's name, the issuing entity's contact information, description of the coupon, expiration date, acceptable forms of coupon presentation, user ratings, terms, timestamps, etc. In accordance with further embodiments of the invention, the coupon repository 130 may include data which directs towards or enables a connection to a destination within a network where a coupon may be located, for example, a URL (Uniform Resource Locator). In this case, the data from the coupon repository may be used to create the hyperlink which is to be associated with the static content that has been determined to be in compliance with the incentive criterion, such that when the hyperlink is executed, the user is directed towards or connected to a network location where the coupon may be obtained.

For example, according to some embodiments of the invention, the coupon publisher 110 may be configured to evaluate the data stored within the coupon repositories 130 associated therewith, and based on the data in the repository 130 the coupon publisher 110 may be adapted to generate incentive criteria and to associate the coupon to which the data in the repository 130 relates with an appropriate incentive criterion. According to some embodiments of the invention, the coupon publisher 110 may be adapted to interrogate a coupon repository 130 routinely, for example, after a predefined time interval, and may update the incentive criteria and the coupons associated with each criterion based upon the changes made since the last update. According to further embodiments of the invention, the coupon publisher 110 may be adapted to update its data in respect of the incentive criteria and/or in respect the coupons associated with each incentive criterion whenever data is written into the repository 130, whenever data is deleted from the repository 130, and/or whenever data in the repository 130 is modified.

For example, according to some embodiments of the invention, in response to receiving within a repository 130 data in respect of a new coupon, the coupon publisher 110 may be adapted to interrogate a description entry of the new coupon. As a result of the interrogation, the coupon publisher may, for example, identify the keywords “pizza” and “delivery” within the description entry. In response, the coupon publisher 110 may utilize predefined rules to generate an incentive criterion in connection with the new coupon. In alternative, the coupon publisher 110 may determine that an incentive criterion for a coupon which, for example, includes the keywords “pizza” and “delivery” has already been created. It should be noted that according to some embodiments of the invention, the rules utilized by the coupon publisher 110 for generating an incentive criterion and/or for associating a coupon with a certain incentive criterion may be not be rigidly associated with a specific keyword or keyphrase nor with any combination of keywords or keyphrases, and rather may allow for various and different combinations of keyword(s) and/or phrases and with respect to various kinds metadata.

In accordance with the example provided here, we assume that the coupon publisher 110 may decide, based on the predefined rules, to generate an incentive criterion. Upon the generation of the incentive criterion or some time thereafter, the coupon publisher 110, either independently or in response to a request, may provide the agent module 120 with data in respect to the incentive criterion to be used for evaluating data being exchanged over the network for compliance with the incentive criterion. For example, in accordance with some embodiments of the invention, upon the identification of the words “pizza” and “delivery” within the description data associated with a coupon or coupons, the coupon publisher 110 may be adapted to generate an incentive criterion in accordance with which the agent module 120 is configured to identify static content which corresponds to the word “pizza” as being compliant with the incentive criterion.

In accordance with the example provided here, when the agent 120 identifies content which is in compliance with the incentive criterion, the agent module 120 may contact the coupon publisher 110 and may request the coupon publisher 110 to provide it with data directing towards the coupons associated with the incentive criterion, or to provide it with data which corresponds to the coupon themselves. In accordance with another embodiment of the invention, the agent 120 may be periodically or on specific occasions (for example, in response to a predefined event) may be provided with data in respect of which coupons are associated with which incentive criterion and with the data directing towards the coupons. In this case, the agent 120 may use the local data instead of being required to contact the publisher 110 whenever content which is in compliance with an incentive criterion is found. This implementation of the invention shall be discussed in further detail below.

According to some embodiments of the invention, whichever way the data in respect of the coupon(s) arrives at the agent module 120, the agent module 120 may be configured to add a hyperlink that is configured to link towards one or more coupons associated with the incentive criterion to the content that has been determined to be in compliance with the incentive criterion. In accordance with the example provided here, the agent module 120 may associate the word “pizza” within the content being exchanged with one a hyperlink that is operative to link towards one or more coupons which are associated with the incentive criterion, and in this case, towards coupons which include the words “pizza” and “delivery” in their description entry. According to some embodiments of the invention, the coupon publisher 110 may be configured to employ any presently known or yet to be devised in the future techniques, including data analysis and data mining techniques, to generate an incentive criterion for a certain coupon or coupons.

According to further embodiments of the invention, the generation of the incentive criterion and the association of the coupons with the incentive criterion may be based upon any set of rules and may either be symmetric or a-symmetric. In other words, the same or alternative (not necessarily the same) words or phrases may be used to evaluate content being exchanged on the one hand, and coupons which are associated with a certain incentive criterion. According to some embodiments of the invention, in case the generation of the incentive criterion and the association of the coupons with the incentive criterion are not symmetric, whenever content within the data being exchanged which is in compliance with a certain incentive criterion is identified, the agent module 120 in cooperation with the coupon publisher 110, for example, may be adapted to search for coupons which are associated with the incentive criterion using a different criterion from the one used for evaluating the content (for example, a repetition of the word pizza may be searched for within the content and the combination of the words “pizza” and “delivery” may be searched for within the description of the coupon).

It should be appreciated that, according to some embodiments of the invention, the coupon publisher 110 may be associated with one or with a plurality of coupon repositories 130. It should be further appreciated that, according to some embodiments of the invention, the coupon repositories 130 may be well defined entities which are continuously and dynamically updated with data in respect of coupons, and/or the coupon repositories 130 may be ad-hoc lists of coupon and associated data. Such ad-hoc lists may be created as a result of a network search for coupons, for example, as a result of “coupon scraping” performed over the Internet. It should be further noted that, according to some embodiments of the invention, a coupon publisher 110 may be associated with a single coupon repository 130 or with a group of coupon repositories, and the agent module 120 may be in communication with each of a plurality of coupon publishers 130 to determine compliance of content being exchanged over a network with an incentive criterion provided by the coupon publishers 130.

According to further embodiments of the invention, the agent module 120 may be adapted to obtain from the coupon publisher 110 data in respect of an incentive criterion, and may be adapted to evaluate data being transferred to and/or from the computerized device 102 to discover therewithin content which complies with the incentive criterion obtained from the coupon publisher 110. When the agent module 120 determines that the data being exchanged includes content that is in compliance with the incentive criterion, the agent module 120 may be adapted to obtain from the coupon publisher 110 data in respect of the coupon(s) associated with the incentive criterion. Based on the data obtained from the coupon publisher in respect of the coupon(s) associated with the incentive criterion, the agent module 120 may be adapted to create a hyperlink which is configured to link towards the coupon(s) that are associated with the incentive criterion. The agent module 120 may be configured to associate the hyperlink with the static content determined to be in compliance with the incentive criterion. Thus, the agent module 120 provides enhanced content 204 in which static content that is in compliance with an incentive criterion is associated with a hyperlink, which is configured to link towards a coupon that is associated with the incentive criterion.

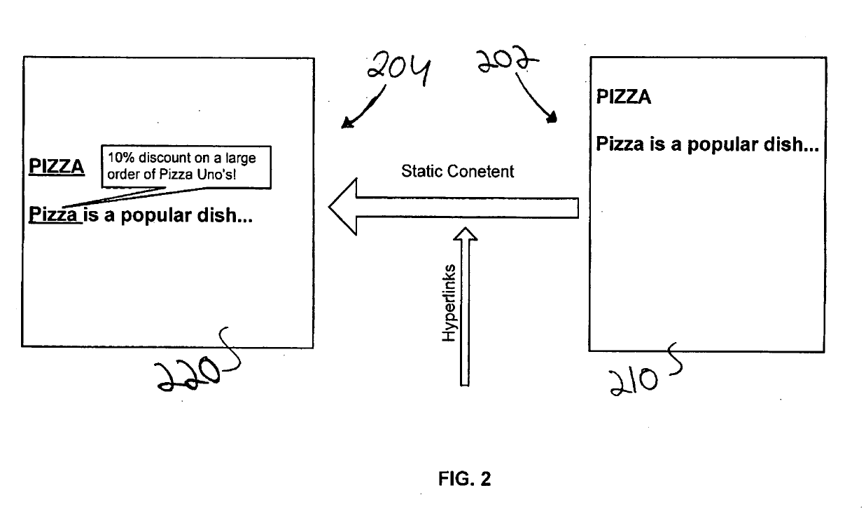

Additional reference is now made to FIG. 2, which is a graphical illustration of a first display 210, displaying original content 202 corresponding to data being exchanged over a network, and of a second display 220, displaying enhanced content 204 created by associating certain words or phrases from the data being exchanged 202 with a hyperlink which is configured to link towards one or more coupons, according to some embodiments of the invention. According to some embodiments of the invention, the agent module 120 is configured to receive data corresponding to at least a portion of the content 202 (as displayed on the first display 210) which is being exchanged over the network, and to evaluate the data being exchanged to identify content that is in compliance with an incentive criterion. In case the agent module 120 finds that the data being exchanged includes static content (or data corresponding to static content) that is in compliance with an incentive criterion, the agent module 120 may be adapted to associate the content 202 with a hyperlink to provide enhanced content 204. The hyperlink associated with the static content is configured to link towards one or more coupons associated with the incentive criterion upon the execution of the hyperlink.

For example, as is shown in FIG. 2, and according to some embodiments of the invention, the agent module 120 receives from the coupon publisher 110 data in respect of a incentive criterion, which in accordance with which, in case the word “pizza” is repeated (twice for example) within the content being exchanged, each instance of the word “pizza” should be associated with a coupon which includes in its description the word “pizza” and “delivery”. Thus, according to some embodiments of the invention, when the agent module 120 detects the repetition of the word “pizza” within the content that is being exchanged 202, the agent module 120, for example, together with the coupon publisher 110, associates each instance of the word “pizza” with a hyperlink that is configured to link towards coupons which include the words “pizza” and “delivery” in its description, thereby providing the enhanced content 204 shown on display 220.

Referring back to FIG. 1, according to further embodiments of the invention, the agent module 120 may include a query processor 122. According to some embodiments of the invention, the query processor 122 may be adapted to associate a hyperlink that is to be added to the content with a query. According to further embodiments of the invention, the query processor 122 may be adapted to associate a query with the hyperlink, such that when the hyperlink is executed the query is initiated, for example automatically, on a coupon repository 110. According to yet further embodiments of the invention, the query processor 122 may be adapted to configure the query, such that in response to the execution of the query, for example when the user clicks on (activates) the hyperlink with which the query is associated, the query is directed towards one or more coupon repositories 130, either directly or through the coupon publisher 110, and is configured to cause the repository 110 to return data in respect of currently available coupons within the repository 110 which are associated with the incentive criterion. According to some embodiments of the invention, the query may be configured such that the query terms includes in addition to the data in respect of the incentive criterion with which the query is associated, data in respect of other terms which the coupons to be returned must satisfy. Such additional terms may include but are not limited to the following terms: personal data of the user, user's name, user's gender, user's personal status, user's occupation, user's hobbies and field of interest, user's age, authentication information, user's geographical location and other contact information, user's preferences, user's usage history, etc.

In accordance with some embodiments of the invention, the agent module 122 may be further adapted to associate a hyperlinked word or phrase with metadata or with a description of the hyperlink. The agent module 122 may provide via the metadata any data in connection with the hyperlink, for example, data in respect of the incentive criterion with which the hyperlink is associated. According to some embodiments of the invention, the metadata associated with the hyperlink may be latent unless the user takes a certain predefined action which is preconfigured to reveal the descriptive data in respect of the hyperlink. For example, according to some embodiments of the invention, the descriptive data in respect of a hyperlink may be revealed to the user when the user positions a pointing device (a computer mouse for example) over the hyperlink. It would be appreciated that by providing the user with the descriptive data, the user may gain a better understanding of what is on offer. The descriptive data may include any data in respect of the coupon which may be associated with the incentive criterion with which the hyperlinked static content is associated or any other kind of data.

According to some embodiments of the invention, the agent module 120 may further include or be associated with a user information module 124. According to some embodiments of the invention the user information module 124 may include data and parameters in respect of the user. For example, the user information module 124 may include the following data: authentication information, the user's geographical location and other contact information, the user's preferences, the user's usage history, etc. According to some embodiments of the invention, the user information module 124 may receive data in respect of the user from the user. Such data may be provided by the user by utilizing any suitable interface device, such as a keyboard, for example or in addition or in alternative, the data may be collected automatically based upon the user's interactions and activity. According to some embodiments of the invention, the user information module 124 may monitor the user's interactions and/or or process data stored on the computerized device to obtain data in respect of the user, such as for example, the user's preferences, data in respect of the user's past usage of coupons, etc.

According to some embodiments of the invention, the query processor 122 may be adapted to access the data stored within the user information module 124. According to some embodiments of the invention, the query processor 122 may be adapted to include terms within the query which are created based upon the data in the user information module 124. It would be appreciated that the inclusion of terms which are based upon user specific data within the query, a (relatively) personalized response to the query may be obtained. For example, in case the incentive criterion is a repetition of the word “pizza” within the content being exchanged, and it is determined that the content is indeed in compliance with the incentive criterion, the query processor 122 may generate a query that is to be associated with the content, and the query may be configured to cause one or more repositories 130 to return coupons (or data in respect of coupons) which are associated with the incentive criterion, for example, the repositories may return data in respect of coupons which include the words “pizza” and “delivery” in their metadata and which provide a match with the user's residence, for example, coupons which include in their metadata reference to the user's area of residence, e.g. Santa Monica in Calif. Similarly, the query processor 122 may be configured to generate other queries which relate to any other data found in the user information module 124.

It would be appreciated that according to some embodiments of the invention, a certain query may return one or more coupons or data in respect of one or more coupons and/or data in respect of a group or groups of coupons (for example, pizza coupons). It would also be appreciated that according to some embodiments of the invention, a query may return different results at different times, based on which coupons are available at the time the query is received and processed. It would be also be appreciated that, in accordance with some embodiments of the invention, the rules governing the generation and definition of certain incentive criteria and/or the rules in accordance with which a certain coupon is associated with a certain incentive criterion may change from time to time, and as a result, an identical query may return different results (coupons) at different times.

The Applicant has discovered that in order to provide for a wide range of relevant and currently available coupons and in order to accurately match a broad range of users' interests and personal attributes (such as, geographical location, age, gender, etc.), very large and dynamic lists of coupons may be needed. These lists may be implemented on centralized repositories, or may be decentralized in nature, for example, may be aggregated from a plurality of sources, for example from the merchants themselves. If such elaborate and dynamic lists are to be used, means should be devised for interfacing with the various data sources so that the user can relatively straightforwardly obtain access to well-targeted and currently available coupons, with minimal disruption to the user's web-surfing experience, especially when the user is not interested in a coupon. Some embodiments of the invention seek to provide a solution for these and other challenges.

In a certain scenario in accordance with some embodiments of the invention, the agent module 120 may be used to evaluate the content received at the computer of the user, while the user browses an auto repair website and the phrase “auto service” and the word “tires” are identified within the incoming content received at the computer of the user. The agent module 120 may recognize the phrase “auto service” and the word “tires” as having coupons associated with them. Taking into account the user's preferences and the then available current coupons, the agent module 120 may be adapted to associate the phrase “auto service” with a hyperlink when executed initiates a query vis-à-vis one or more coupon repositories 130 with the search term “auto service” and the user's location and other information. The query is then satisfied by a coupon repository 130, via an API, with coupons from auto service shops in the user's local area. The word “tires” is associated with coupons from local tire shops and also online stores that sell tires. The user may have the option to define preferences for coupons associated with text, such as defining which terms are associated with coupons, which establishments' coupons are not displayed, how many times the same term is converted to a hyperlink in a single page, etc.

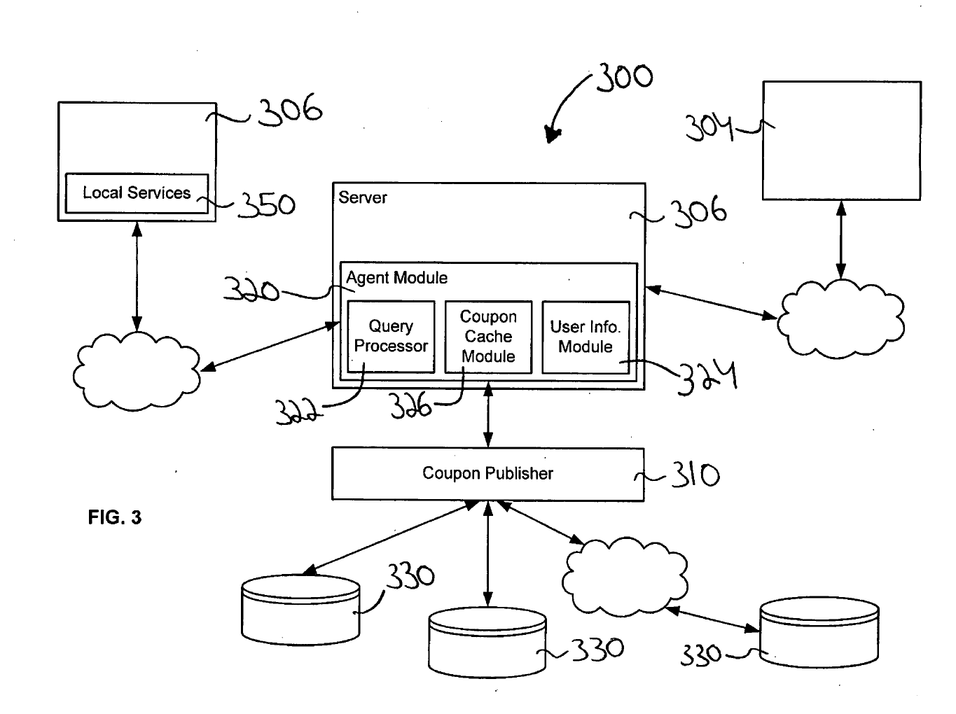

Reference is now made to FIG. 3, which is a block diagram illustration of a system for enabling a user utilizing a computerized device connected to a network to receive targeted incentive offers, according to further embodiments of the invention. As is shown in FIG. 3, and according to some embodiments of the invention, the agent module 320 may be implemented outside the computerized device to which the enhanced content is to be provided. In FIG. 3 and according to some embodiments of the invention, the agent module resides within a server 306 positioned in the path of the content being exchanged between the first and the second computerized devices 302 and 304. For example, according to some embodiments of the invention, the agent module 320 may be implemented on a service provider's server 306. The service provider may be a provider of infrastructure or of services or any other entity which is able to control and modify content being exchanged between two computerized devices over a network. For example, the service provider may be an Internet service provider (providing access to the Internet), a telephone service provider (wireless or wired), a television service provider (e.g. cable, broadcast or satellite TV company), an entity that hosts the user's content, such as a remote storage service provider, an Internet-based email service provider, or any number of service providers that aggregate or host information on behalf of the user.

According to some embodiments of the invention, the agent module 320 on the service provider's server 306 may be adapted to monitor data being exchanged between the first and the second computerized devices 302 and 304. The agent module 320 may be configured to identify static content which is being exchanged and that is in compliance with an incentive criterion. The incentive criterion/a used in evaluating the content flowing to and/or from the computerized device 302 may be provided to the agent module 320 by a coupon publisher 310, as was described above in greater detail.

According to some embodiments of the invention, once the agent module 320 identifies content that it is in compliance with an incentive criterion, the agent module 320 may be adapted to add to the content a hyperlink which is operative to link upon the execution of the hyperlink towards. one or more incentive offers or coupons which are associated with the incentive criterion, as was described above in further detail. According to some embodiments of the invention, the agent module 320 may be adapted to forward the enhanced content (the content with the hyperlinks) to the first computerized device 302, such that the content is displayed on the computerized device 302 together with the hyperlinks and when the user executes the hyperlink, the user is directed towards one more coupons associated with the incentive criterion. As was also described above in further detail, according to some embodiments of the invention, the agent module 320 may be adapted to associate the hyperlink with a query which is operative for causing one or more coupon repositories 330 to return data in respect of currently available coupons within the repository 330 which are associated with the incentive criterion.

According to some embodiments of the invention, the agent module 320 residing on the service provider's server 306 may include a coupon cache module 326. According to some embodiments of the invention, the coupon cache module 326 may be used to provide data in respect of the incentive criterion/a that is to be used for evaluating the data being exchanged between the first and the second computerized devices 302 and 304, so that the server 306 is not required to obtain the data in respect of the incentive criterion from the coupon publisher 310 for each interaction of the first and second computerized devices 302 and 304. For example, according to some embodiments of the invention, the coupon cache module 326 may be adapted to maintain a local copy of the keywords incentive criteria that are associated with individual coupons or groups (e.g. categories) of coupons and which are to be used for evaluating the content being exchanged.

According to further embodiments of the invention, the coupon cache module 326 may also include data directing towards individual coupons or groups of coupons which are associated with each incentive criterion. Thus, according to some embodiments of the invention, whenever the agent module 320 identifies within the data being exchanged content that is in compliance with the incentive criterion (obtained from the coupon cache module 326), the coupon cache module 326 may be consulted to obtain data directing towards individual coupons or groups of coupons which are associated with the incentive criterion. Based on the data from the coupon cache module 326, the agent module 320 may be adapted to add to the content that has been determined to be in compliance with the incentive criterion.

According to further embodiments of the invention, whenever the agent module 320 identifies within the data being exchanged content that is in compliance with the incentive criterion (obtained from the coupon cache module 326), the agent module 320 may be adapted to generate a query that is configured to return coupons which are associated with the incentive criterion when the query is activated, and may associate the query with a hyperlink that is added or associate with the static content determined to be incompliance with the incentive criterion. According to some embodiments of the invention, as mentioned above, the agent module 320 may be adapted to include in the query additional terms, such as terms which are associated with personal data, preferences or attributes of the user, for example.

According to some embodiments of the invention, when the query is activated, for example, when the hyperlink with which the query is associated is clicked on, the computerized device 302 may indicate to the server 306 and specifically to the agent module 320 located thereon that the query has been activated or the computerized device 302 may simply forward the query or data about the query back to the agent module 320, so that the agent module 320 may operate to service the activated query. According to some embodiments of the invention, upon receiving the indication that the query has been activated, the agent module 320 may be configured to direct the query towards the coupon cache module 326 to obtain from the coupon cache module 326 data in respect of coupons which satisfy the query. In case the query returns data in respect of a coupon or coupons, the agent module 320 may be adapted to forward the data in respect of the coupon to the computerized device 302. According to some embodiments of the invention, the data received at the agent module 320 in response to a query may require processing before it can be used to gain access to or to obtain a coupon or coupons. The processing may be performed at the agent module 320, so that when the data is received at the computerized device 302 it is ready to be used.

It should be appreciated that, in accordance with further embodiments of the invention, the agent module 320 may be configured to select to whether an activated query is to be directed the coupon cache module 326, to the coupon publisher 310 or to a specific coupon repositories or repositories 330. According to some embodiments of the invention, the decision where to direct an activated query may be based upon predefined criteria, for example, the decision may be based upon network congestion parameters, a pending queries queue (or the lack thereof), the identity of the computerized device which activated the query, etc.

According to some embodiments of the invention, the coupon cache module 326 may be adapted to synchronize with the coupon repositories 330, either directly or through the coupon publisher 310. The coupon cache module 326 may be adapted to synchronize with the coupon repositories 310 routinely or in response to an event, for example. For example, the coupon cache module 326 may include a timestamp indicating the time of the most recent synchronization and the coupon cache module 326 is synchronized after a predefined amount of time passes from the most recent synchronization. In accordance with another embodiment of the invention, the coupon cache module 326 may be synchronized after each evaluation of network interaction. It would be appreciated that by continuously refreshing the data in the coupon cache module 326, relatively up-to date data is maintained locally. This data may be used to create a hyperlink directing towards the coupon, such that the hyperlinks are created based on relatively fresh data.

According to some embodiments of the invention, as an alternative to utilizing the coupon cache module 326, the agent 320 could access an API and directly query the coupon repositories 310 for the appropriate coupons in real-time. However, it should be appreciated that this approach may be bandwidth intensive and may introduce latency into the application. Accordingly, in accordance with some embodiments of the invention, the coupon cache module 326 may be used intermittently as needed, for example, when the amount of bandwidth available for the server 306 is below a predefined threshold, or in accordance with another example, when the agent module 320 is unable to handle all the incoming content in real-time and communications are thus being delayed or dropped.

It would be appreciated that according to some embodiments of the invention, a coupon cache module may be implemented locally on a computerized device whose content is to be enhanced, rather than on an intermediary server. For example, a coupon cache module similar to the one described above may be implemented on the computerized device 102 discussed with reference to FIG. 1.

According to some embodiments of the invention, the service provider's server may include a user information module 324. The user information module may include various data about the user utilizing computerized device 302. For example, the user information module 324 may include one or more of the flowing: personal data about the user, authentication information, the user's geographical location and other contact information, the user's preferences, the user's usage history. According to some embodiments of the invention, the user information module 324 may be operatively connected to a user data source locate on the computerized device 302 utilized by the user, or in accordance with other embodiments of the invention the user information module 324 implemented on the service provider's server 306 may be independent and include data collected or otherwise provided to the server 306.

In FIG. 3, and according to some embodiments of the invention, in case the agent module 320 is implemented outside the computerized device 302 which is to be provided with the enhanced content, the computerized device 302 may include a local services module 350. According to some embodiments of the invention, the local services module 350 may be adapted to interact with the agent module 320 and/or with any other component of the system 300 to system's functionality. For example, the local services module 350 may be adapted to perform local operations on the computerized device 302 in accordance with instructions received from the agent module 320 or any other component of the system 300 may perform local processing operation in support of the functionality of agent module 320 or any other component of the system 300, and may provide data to the agent module 320 or to any other component of the system 300 in support of its operation. For example, according to some embodiments of the invention, the local services module 350 may be configured to identify when the user activates a metadata display option in respect of a certain hyperlink inserted into or otherwise associated with previously static content for providing a link towards a coupon(s) associated with that content, so that the user is present with metadata about the coupon, for example. In accordance with another example, the local services module 350 may be responsible for contacting the agent module 320 whenever a hyperlink inserted into the content or otherwise associated with the content is executed (together with any necessary data). In accordance with another example, the local services module 350 may be adapted to further filter the results of a query for coupon in accordance with locally implemented filters, for example, in accordance with filters defined by the user. According to some embodiments of the invention, the local services module 350 may be implemented using any available technique, including but not limited to, using a java script, using various APIs, using a dedicated piece of software and as a browser extension, applet, application, etc.

In a certain scenario in accordance with some embodiments of the invention, a user may send content to another user's device through an instant messaging service provider such as AOL of Virginia, USA, for example, which operates the popular AOL Instant Messenger (AIM). The instant messaging service provider may utilize an agent module installed on its servers to evaluate the packets of content. For illustration, we assume that the agent module discovers that the word “pizza” is included in the message. The agent module may verify that the word “pizza” acts as an incentive criterion, as explained above in greater detail. According to some embodiments of the invention, the agent would then query a repository of information about the recipient's location, preferences, etc. (optional) and may locate either through an ad-hoc global search of the network or through a more focused search on predefined resources within the network, such as on dedicated coupon servers or repositories, for appropriate and currently available pizza coupons. It should be noted, that in accordance with further embodiments of the invention, the query is executed only later, for example, when the user chooses to execute the query. It should also be noted that the query may or may not include the word “pizza” and may or may not include other words and terms, such as personal data in respect of the user for example.

In case in response to the query it is determined that there is at least one coupon available which satisfies the query, the agent module may convert the word pizza from static text to a hyperlink pointing to the appropriate coupon(s). Optionally, the agent module may also add metadata about the coupons such as short descriptions, user ratings, and locations that could be exploited. The agent may be configured to cooperate with a local service running on the user's computerized device to generate the metadata. The local service may also be used to control the display of the metadata to the user, for example when the user places his computer mouse above the hyperlink. The intended party thus receives the instant message which now carries additional information that includes a hyperlink towards one or more pizza coupons and the metadata about the one or more coupons. If the local service exists on the recipient's computing device, then some action, e.g. a right mouse click, hovering over the link, etc. could signal the local services to display the metadata about the associated coupons, as mentioned above.

According to another scenario in accordance with some embodiments of the invention, an individual browsing the Internet from a mobile phone may be involved. The service provider, in this case the mobile phone service provider (e.g. Verizon Communication Inc., Wilmington, USA) could operate the agent module to evaluate the text on third-party websites. Consider, for example a user located in Belmont, Calif., browsing a website that contains information about Iron Gate restaurant, for example. The agent module may identify the combination of the name of the restaurant “Iron Gate” and its location “Belmont” within the text of a third party's website as the content is being received at the mobile phone (for example, for being displayed on the mobile phones screen) and may recognize that the above combination is associated with various coupons, for example, with coupon for the Iron Gate restaurant. In response, the agent module may generate a query that specifies the search term “Iron Gate” and includes parameters such as the category “restaurant”, the location “Belmont, CA”, etc. This query may then be embedded into a hyperlink that is appended to the static text on the third-party webpage viewed by the user. When the user clicks on this hyperlink, it generates a ad-hoc query for any coupons that satisfy these criteria. This query might be satisfied from the Verizon coupon cache or directly from one or more coupon repositories via their API(s).

According to yet another scenario in accordance with some embodiments of the invention, a hosted service accessible via a browser, like Gmail from Google of California, USA, for example, may be involved. The emails may be processed using an agent installed on the web-mail provider's servers to discover certain words in the body, subject line or even attachments of the emails of a user utilizing the service which are associated with incentive criteria. The service provider, for example based upon an evaluation of the user's prior history (User Info) with coupon, may determine which hyperlinks and keywords are most appealing to that individual. The service provider may then utilize the agent module to turn the various phrases or words into hyperlinks (with either direct links to coupons or embedded queries) with the appropriate metadata displayed when the individual moves a cursor over the hyperlink or clicks it with the right mouse button, or in some other way indicates a desire for additional information. Clicking the hyperlinks may link towards the appropriate coupons.

According to still another scenario in accordance with some embodiments of the invention, a user may create an appointment to have lunch with an associate at the Red Lobster restaurant using a calendar application such as Outlook from Microsoft Corporation. Outlook may then send a message to the associate that includes the time, date, location, etc. of the lunch. The agent module may identify the name/phrase “Red Lobster” as being associated with an incentive criterion. In response, the agent module may associate the name/phrase “Red Lobster” with one or more coupons offered by Red Lobster, taking into account issues such as the date and time, number of participants and other information that might influence which coupons are valid under this scenario. Upon clicking on the newly created hyperlink in the Outlook invitation, the associate is presented with a selection of coupons for Red Lobster. Upon selecting a coupon, the user is presented with that coupon from the hosted coupon repository.

It would be appreciated that the agent module may be used to evaluate data transactions between a plurality of computerized devices and that the present invention is not limited to the data exchanges between two computerized devices. It should be further noted, that according to some embodiments of the invention, an agent module residing on a service provider's server, as well as other components of the system described above, may be configured to evaluate or to participate in the evaluation of several simultaneous data exchanges between various users, and that various processes described above may multiplied as applicable and multiple instances of the above processes may occur simultaneously. Similarly, in accordance with some embodiments of the invention, an agent module residing on a service provider's server, as well as other components of the system described above, may be configured to simultaneously associate different contents being exchanged (for example, between different users) with various hyperlinks which are configured to link towards relevant coupons when executed. According to further embodiments of the invention, an agent module residing on a service provider's server, as well as other components of the system described above, may be configured to simultaneously generate a plurality of queries that are to be embedded within a plurality of hyperlinks that are to be associated with different contents being exchanged.

It will also be understood that the system according to the invention may be a suitably programmed computer. Likewise, the invention contemplates a computer program being readable by a computer for executing the method of the invention. The invention further contemplates a machine-readable memory tangibly embodying a program of instructions executable by the machine for executing the method of the invention.

While certain features of the invention have been illustrated and described herein, many modifications, substitutions, changes, and equivalents will occur to those skilled in the art. It is therefore to be understood that the appended claims are intended to cover all such modifications and changes as fall within the true scope of the invention.

1. A system for enabling a user utilizing a computerized device connected to a network to receive targeted incentive offers, said system comprising:
a coupon publisher adapted to associate one or more coupons with one or more a predefined incentive criterion;
an agent operative to evaluate at least a portion of data being exchanged between said computerized device and at least a second computerized device to identify data corresponding to static content which is in compliance with the incentive criterion; and
said agent being further adapted to associate the static content determined to be in compliance with the incentive criterion with a hyperlink which is configured to link towards one or more coupons associated with the incentive criterion upon the execution of the hyperlink.

2. The system according to claim 1, wherein said agent comprises a query processor for associating the hyperlink with a query, such that when the hyperlink is executed the query is initiated on a coupon repository.

3. The system according to claim 2, wherein said query processor is adapted to configure the query to retrieve from the repository data in respect of any currently available coupons within the repository which are associated with the incentive criterion upon the initiation of the query.

4. The system according to claim 3, further comprising a user information module comprising personal data about the user, and wherein said query processor is adapted to include within the query one or more terms created based upon data from said user information module.

5. The system according to claim 4, wherein said user information module comprises any of the following data with respect to a user: personal data of the user, user's name, user's gender, user's personal status, user's occupation, user's hobbies and field of interest, user's age, authentication information, user's geographical location and other contact information, user's preferences, user's usage history.

6. The system according to claim 3, wherein said agent is utilized by a service provider to evaluate compliance of content being exchanged through the service provider with a predefined incentive criterion, and wherein said agent is adapted to associate static content determined to be in compliance with the incentive criterion with a hyperlink which is configured to link towards one or more coupons associated with the incentive criterion upon the execution of the hyperlink.

7. The system according to claim 6, wherein said agent is utilized by the service provider to associate static content determined to be in compliance with the incentive criterion with a hyperlink which is configured to link towards one or more coupons associated with the incentive criterion, such that the content arrives to its destination with the hyperlinks associated therewith.

8. The system according to claim 1, further comprising a coupon cache module, said coupon cache module being adapted to obtain from said coupon publisher data in respect of an incentive criterion to enable said agent module to evaluate content being exchanged in accordance with the incentive criterion without having to consult the coupon publisher with respect to the incentive criterion.

9. The system according to claim 1, wherein said agent module is adapted to associate the hyperlink with metadata to provide descriptive data in respect of the coupons associated with the incentive criterion.

10. A method of enabling a user utilizing a computerized device connected to a network to receive targeted incentive offers, said method comprising:
associating one or more coupons with one or more a predefined incentive criterion;
evaluating at least a portion of data being exchanged between said computerized device and at least a second computerized device to identify data corresponding to static content which is in compliance with the incentive criterion; and
associating the static content determined to be in compliance with the incentive criterion with a hyperlink which is configured to link towards one or more coupons associated with the incentive criterion upon the execution of the hyperlink.

11. The method according to claim 10, wherein said associating further comprises associating the hyperlink with a query, such that when the hyperlink is executed the query is initiated on a coupon repository.

12. The method according to claim 11, wherein said associating the hyperlink with a query further comprises configuring the query to retrieve from the repository data in respect of any currently available coupons within the repository which are associated with the incentive criterion upon the initiation of the query.

13. The method according to claim 12, wherein said associating the hyperlink with a query comprises including within the query one or more terms created based upon user information.

14. The method according to claim 13, wherein said including comprises:
accessing a data source including information about the user; and
generating a query term to be incorporated into the query based upon data from the data source including information about the user.

15. The method according to claim 12, wherein said evaluating further comprises intercepting the data being exchanged before the data arrives to its destination, and wherein said associating the content with a query is by an intermediate computerized device, such that the content arrives to its destination together with the hyperlinks.

16. A program storage device readable by machine, tangibly embodying a program of instructions executable by the machine to perform method steps of enabling a user utilizing a computerized device connected to a network to receive targeted incentive offers, said method comprising:
associating one or more coupons with one or more a predefined incentive criterion;
evaluating at least a portion of data being exchanged between said computerized device and at least a second computerized device to identify data corresponding to static content which is in compliance with the incentive criterion; and
associating the static content determined to be in compliance with the incentive criterion with a hyperlink which is configured to link towards one or more coupons associated with the incentive criterion upon the execution of the hyperlink.

17. A computer program product comprising a computer useable medium having computer readable program code embodied therein of enabling a user utilizing a computerized device connected to a network to receive targeted incentive offers, said computer program product comprising:
computer readable program code for causing the computer to associate one or more coupons with one or more a predefined incentive criterion;
computer readable program code for causing the computer to evaluate at least a portion of data being exchanged between said computerized device and at least a second computerized device to identify data corresponding to static content which is in compliance with the incentive criterion; and
computer readable program code for causing the computer to associate the static content determined to be in compliance with the incentive criterion with a hyperlink which is configured to link towards one or more coupons associated with the incentive criterion upon the execution of the hyperlink.
